(19) United States
(12) Patent Application Publication
(10) Pub. No.: US 2026/0131725 A1
(43) Pub. Date: May 14, 2026

(54) SPLASH AVOIDANCE TO ADDRESS ROAD USER SAFETY

(71) Applicant: Volvo Car Corporation, Göteborg (SE)

(72) Inventor: Ehsan Yasari, Gothenburg (SE)

(21) Appl. No.: 18/945,048

(22) Filed: Nov. 12, 2024

(51) Int. Cl. B60Q 9/00; G01W 1/02; G05B 13/02; G06V 10/764

(52) U.S. Cl. CPC B60Q 9/00; G05B 13/028; G06V 10/764; G01W 1/02

(57) ABSTRACT

A system of a vehicle comprises: a processor; and a memory communicatively coupled to the processor, the memory having stored therein computer-executable components. a receiving component that receives vehicle environment data from a set of sensors along with current or historical weather data; and a machine learning component configured to train a model which that learns from vehicle environment, current or historical weather data, vehicle tire attributes, vehicle weight, vehicle speed, determined or inferred puddles and possibly other acquired data, and generates a probabilistic-based assessment relating to operation of the vehicle; and an execution component that, based on the assessment provided by the trained model, generates a course of actions mitigating splashing of road users in proximity to the vehicle.

### TECHNICAL FIELD

Embodiments disclosed and claimed herein relate to mitigating water splashing of road users, such as pedestrians, cyclists, or any other vulnerable road user by a motor vehicle.

### BACKGROUND

Splashing of water by passing cars can pose significant problems for pedestrians and cyclists, leading to discomfort, inconvenience, and potential safety hazards as well as fines for careless drivers. In urban areas with heavy traffic and frequent rainfall, pedestrians walking along sidewalks or waiting at crosswalks are vulnerable to sudden splashes caused by passing vehicles.

### SUMMARY

The following presents a summary to provide a basic understanding of one or more embodiments of the invention (can also be referred to as innovation). This summary is not intended to identify key or critical elements or delineate any scope of the different embodiments or any scope of the claims. Its sole purpose is to present concepts in a simplified form as a prelude to the more detailed description that is presented later. This innovation addresses those concerns utilizing machine learning (ML) techniques, also referred to as artificial intelligence (AI) techniques, with an emphasis on tire profiles and current and historical weather forecasts to mitigate the risk for vulnerable road users such as for example pedestrians, cyclists, and drivers are exposed to. In the content described within by, the term ML represents machine learning and the terms ML method, ML process, ML algorithm can be used interchangeably. In one or more embodiments described herein, systems, computer-implemented methods, apparatus and/or computer program products are presented that facilitate mitigation of water splash created by a vehicle driving over a puddle (or the like) impacting a pedestrian and/or a cyclist (throughout this document the terms “pedestrian” or “cyclist” are used to represent any vulnerable road user, and when used they can refer to a single entity or any number, or combination, of stationary and/or moving vulnerable users). Embodiments relate to applied utilization of current and historical weather data along with the weather forecast, tire tread condition and other extrinsic data in a ML learning process.

According to one or more embodiments, a system of a vehicle, comprising: a processor; and a memory communicatively coupled to the processor, the memory having stored therein computer-executable components, comprising: a receiving component that receives vehicle environment data from a set of sensors along with current or historical weather data; and a machine learning component configured to train a model which that learns from vehicle environment, current or historical weather data, vehicle tire attributes, vehicle weight, vehicle speed, determined or inferred puddles and possibly other acquired data, and generates a probabilistic-based assessment relating to operation of the vehicle; and an execution component that, based on the assessment provided by the trained model, generates a course of actions mitigating splashing of road users in proximity to the vehicle.

According to one or more embodiments, a computer-implemented method comprising, receiving by a system of a vehicle, vehicle environment data from a set of sensors along with current or historical weather data; configuring by the system machine learning to train a model which learns from vehicle environment, current or historical weather data, vehicle tire attributes, vehicle weight, vehicle speed, determined or inferred puddles and possibly other acquired data, and generates by the system a probabilistic-based assessment relating to operation of the vehicle; and executing by the system, based on the assessment provided by the trained model, a course of actions mitigating splashing of road users in proximity to the vehicle.

According to one or more embodiments, a system of a vehicle, comprises: a processor communicatively coupled to memory having stored therein computer-executable instructions, comprising: a receiving component that receives vehicle environment data from a set of sensors along with current or historical weather data; a machine learning component configured to train a model that learns from vehicle environment, current or historical weather data, vehicle tire attributes, vehicle weight, vehicle speed, determined or inferred puddles, and generates a probabilistic-based assessment relating to operation of the vehicle; and an execution component that, based on the assessment provided by the trained model, generates a course of actions mitigating splashing of road users in proximity to the vehicle.

### DESCRIPTION OF THE DRAWINGS

FIG. 1 illustrates a block diagram of an example, non-limiting system that facilitates the implementation of mitigating splash impact on pedestrians and/or cyclists in accordance with one or more embodiments described herein.

FIG. 2 illustrates a diagram of an example vehicle depicting distinct types of sensors used in the application in accordance with one or more embodiments described herein.

FIG. 3 illustrates a diagram of various transportation entities that can use the splash mitigating application in accordance with one or more embodiments described herein.

FIG. 4 presents a diagram of the distinct types of machine learning methods that can be used for this application in accordance with one or more embodiments described herein.

FIG. 5 presents an illustration of an example scenario in which this application can be implemented in accordance with one or more embodiments described herein.

FIG. 6 illustrates part 1 of a flow diagram for this application shown as a sequence of events in accordance with one or more embodiments described herein.

FIG. 7 illustrates part 2 of a flow diagram for this application shown as a sequence of events in accordance with one or more embodiments described herein.

FIG. 8 illustrates a communication diagram for vehicle-to-vehicle data transmission supporting multiple vehicles in accordance with one or more embodiments described herein.

FIG. 9 illustrates a block diagram of an example, non-limiting operating environment in which one or more embodiments described herein can be facilitated.

FIG. 10 illustrates an example networking environment operable to execute various implementations described herein.

### DETAILED DESCRIPTION

The following detailed description is merely illustrative and is not intended to limit, claims, embodiments and/or application or uses of embodiments. Furthermore, there is no intention to be bound by any expressed or implied information presented in the preceding Summary section or in the Detailed Description section.

One or more embodiments described herein is directed to automatically sensing standing water or puddles on a roadway in order to allow a vehicle or a person to take corrective actions in various scenarios that could have impact to pedestrians, drivers, and/or vehicle health by effectively avoiding a potential splash. In urban areas with heavy traffic and frequent rainfall, pedestrians walking along sidewalks or waiting at crosswalks are vulnerable to sudden splashes caused by passing vehicles. The detection of standing water on a road can also be shared centrally in order to populate a database of current conditions that can be shared with other vehicles or drivers.

Driving through a puddle and creating a splash is undesirable and even potentially risky for a number of reasons. Splashing pedestrians or cyclists near or on the roadway is an unpleasant experience and courteous drivers try to avoid this situation when possible and therefore avoid discomfort and inconvenience to the pedestrian as well as potential for inadvertent injury to self or others. Unfortunately, these situations can arise unexpectedly due to several factors such as reduced visibility due to weather or time of day, driver distraction, lack of driver in an autonomous vehicle to name a few. Even when a driver is aware, these situations can lead to panic braking. “Panic braking” refers to the sudden and often uncontrolled application of brakes by a driver in response to an unexpected or emergency situation. It typically occurs when a driver perceives an imminent collision or danger and reacts by abruptly engaging brakes without sufficient thought or planning.

There can be legal consequences for driving through a puddle and splashing a pedestrian or a cyclist depending on jurisdiction and circumstances of an incident. While laws vary by region, some potential legal consequences can include a traffic violation due to driving in a manner that endangers pedestrians or other road users. This might include driving through a puddle at high speed with no concern about splashing pedestrians. Reckless driving laws typically prohibit operating a vehicle in a manner that demonstrates a disregard for the safety of others. Deliberately splashing pedestrians could be considered reckless driving in some jurisdictions. Careless driving is similar to reckless driving, and likewise careless driving laws prohibit operating a vehicle without due care and attention for the safety of others. Splashing pedestrians through reckless or negligent driving could fall under this category. Civil liability can result if a pedestrian is injured, or property is damaged as a result of being splashed by a vehicle—the driver may be liable for such damages. This could include covering cost(s) of medical bills, property damage, and other related expenses. Criminal charges may result in extreme cases, particularly if the incident resulted in severe outcome, criminal charges such as assault or vehicular manslaughter could be pursued against the driver. It is important for drivers to exercise caution and drive responsibly, especially when encountering pedestrians or other vulnerable road users. Splashing pedestrians not only poses a risk to their safety but can also result in legal consequences for the driver.

Driving through a puddle and creating a splash can present safety risks to the operator of the vehicle as well as potential damage to the vehicle and roadway. Splashing through a puddle can create a spray of water that reduces visibility for you and other drivers on the road. This reduced visibility can increase the risk of accidents, especially if there are pedestrians or cyclists nearby who might not be easily visible through the spray. Puddles can obscure road conditions such as potholes that can lead to vehicle damage when driven through.

When you drive through a puddle at high speed, there is a risk of hydroplaning. Hydroplaning occurs when your tires lose contact with the road surface due to a layer of water between the tires and the road. This can cause you to lose control of your vehicle, leading to accidents. Aquaplaning is similar to hydroplaning but typically occurs at higher speeds. It happens when your tires cannot channel away all the water on the road surface, causing your vehicle to skim on top of the water rather than grip the road. This can lead to loss of control and potentially serious accidents. Driving through puddles at high speeds can exacerbate road surface damage. The force of the water can erode road surfaces and contribute to pothole formation, which poses risks to all road users. Driving through puddles can contribute to localized flooding and may be prohibited in certain areas during heavy rainfall to prevent further water accumulation.

Puddles on roads can form in numerous ways depending on local conditions and circumstances. Rain puddles which can form after heavy rain, especially in low-lying areas or where drainage is poor. Potholes can collect water, creating small puddles within them. These can be particularly hazardous as they are often difficult to see and may hide the depth of the pothole. During winter melting snow puddles result after snow accumulates on roads and sidewalks. As temperatures rise, this snow melts and forms puddles, which can linger for some time if drainage is insufficient.

Underground water pipes can sometimes leak, causing water to seep up through cracks in the road surface and form puddles. In agricultural areas, irrigation can sometimes lead to excess water flowing onto roads, creating puddles, especially if the road is poorly maintained. In urban areas, water from car washes or other cleaning activities can flow onto roads, particularly if there is a slope, forming puddles. During construction or road maintenance activities, water used for cleaning or from disrupted drainage systems can accumulate on roads, forming temporary puddles until they evaporate or drain away.

Road puddles have an impact to all types of vehicles including but not limited to personal automobiles, busses, trucks, motorbikes, and autonomous vehicles.

Real world information such as weather data is utilized in the splash avoidance algorithm in order to determine when and how to scan for puddles. This data can include current and historical weather conditions along with weather forecasting. For this innovation, the weather data will also determine how often the algorithm will be utilized to scan the road, which can optimize the total usage of the system. The data is then utilized to put weight on the credibility of water puddle identification. i.e., it is more likely to identify a water puddle if the weather was rainy in that region. Weather conditions play a crucial role in determining the frequency, size, and duration of road puddles. Drivers should be aware of how weather conditions can affect road conditions and adjust their driving behavior accordingly to ensure their safety and the safety of others on the road. Weather data is used to assist with splash detection.

Weather data for machine learning can be gathered from various sources and in different formats. Some common methods and sources used to collect weather data include weather stations. Traditional weather stations are equipped with instruments to measure various meteorological parameters such as temperature, humidity, air pressure, wind speed, and precipitation. These stations are often operated by meteorological agencies and provide reliable, localized data.

Satellites equipped with sensors can capture images of the Earth's surface and atmosphere. These satellite images can be used to derive information about cloud cover, temperature patterns, sea surface temperature, and other weather-related parameters. Satellite data is valuable for obtaining a broader view of weather patterns over large geographic areas.

Doppler radar systems can detect precipitation, measure its intensity, and track its movement in real-time. Radar data is commonly used for short-term weather forecasting and for monitoring severe weather events such as thunderstorms and hurricanes.

Many meteorological agencies and commercial weather providers offer Application Programming Interfaces (APIs) that allow developers to access weather data programmatically. These APIs typically provide access to current weather conditions, forecasts, historical data, and sometimes specialized weather products.

Numerical weather prediction models simulate the Earth's atmosphere using complex mathematical equations. These models consider various atmospheric variables and physical processes to forecast future weather conditions. Weather data generated by these models can be used for medium to long-term forecasting and for understanding large-scale weather patterns.

In addition to traditional weather stations, weather sensors and instruments can be deployed in various locations to gather real-time data on specific meteorological parameters. For example, sensors mounted on vehicles or weather buoys can collect data on temperature, humidity, and other variables in remote or hard-to-reach locations.

Once weather data is collected, it is typically preprocessed, cleaned, and formatted before being used for machine learning tasks such as weather prediction, classification, or anomaly detection. Feature engineering techniques may also be applied to extract relevant information from raw weather data and to create input features for machine learning models. This invention introduces an avoidance splash system along with a warning system using comprehensive weather data and tire profiles that can either operate automatically, autonomously, or with driver involvement to mitigate the issue of splashing. By doing so, it aims to enhance safety in traffic and improve comfort and protection for pedestrians and cyclists. This system can utilize advanced algorithms including machine learning models to identify water puddles on the road as well as pedestrians and cyclists on the sidewalks of the street. This will offer the capability to detect these scenarios early and proactively, either automatically, or by involving the driver, facilitating timely deceleration, and/or maneuvering to prevent splashing and abrupt, panic braking. Embodiments advantageously utilize weather data along with tire tread specifications in addition to sensors to make ML decisions.

The proposed solution can be automatic or involve the driver by notifying them about approaching water puddles and potential splashing situations. Therefore, case the responsibility from the driver to actively check for the water puddles for splash avoidance. Upon detecting these scenarios, the system would initiate deceleration well in advance of reaching the water puddle or plan for a slight maneuver to prevent splashing and avoid the need for panic braking. It can alternatively warn the driver about approaching a water puddle, and potential splash risk if it detects pedestrians or cyclists in that area. The system can potentially estimate the time that pedestrians or cyclists may reach the water puddle spot and check with the time where a vehicle may get there to decide on the needed action. In the case of autonomous cars, this will be done automatically. Also, cars will share information about the GPS location of these water puddles with other cars with connectivity capability, so those cars can benefit from the splash avoidance feature. The innovation can also capture situations where puddles are located within a pothole, or a dry pothole based on sensors. This will allow the system to categorize any type of puddle and pothole into an internal geographical database to assist drivers in avoiding potholes in the future as they can cause severe damage to the vehicle or redirect the vehicle into pedestrians or cyclists.

Various embodiments are described with reference to the remote control of an automobile (or car). However, the disclosed techniques are not limited to automobiles and can be adapted to facilitate its use in distinct types of vehicles and modes of transportation (e.g., a truck, a bus, motorcycles, etc.). The disclosed techniques can also be applied to facilitate interfacing with content in other domains (e.g., other than vehicles such as remote servers) that generally employ remote communication to interface with a system or device.

One or more embodiments are now described with reference to the drawings, wherein like referenced numerals are used to refer to like elements throughout. In the following description, for purposes of explanation, numerous specific details are set forth in order to provide a more thorough understanding of one or more embodiments. It is evident, however, in various cases, that one or more embodiments can be practiced without these specific details.

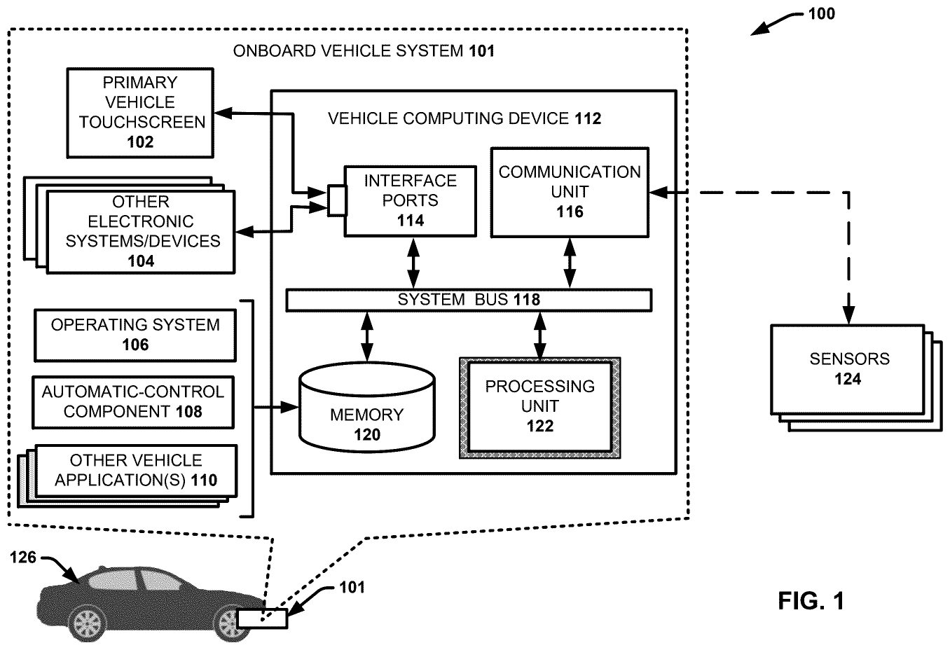

Turning now to the drawings, FIG. 1 illustrates a block diagram of an example, non-limiting system 100 that facilitates sensor inputs that can drive vehicle functions and applications that can be accessed by touch controls displayed on a vehicle touchscreen rendered by sensors 124. In accordance with various exemplary embodiments, system 100 can be deployed on or within a vehicle, such as an automobile 126, to facilitate receiving sensor inputs to assist in controlling one or more functions or applications of the automobile 126.

In this regard, system 100 can include an onboard vehicle system 101 that comprises a primary vehicle touchscreen 102, one or more other electronic systems/devices 104 of the vehicle, and a vehicle computing device 112. System 100 further includes one or more sensor device(s) 124 that can be communicatively and operatively coupled to the vehicle computing device 112 of the onboard vehicle system 101 either via a wireless or wired connection.

The primary vehicle touchscreen 102 (can be part of a complete infotainment system) can display one or more interactive graphical user interface (GUI) s that facilitate information delivery, accessing and/or controlling various functions and/or applications of the vehicle (e.g., automobile 126). This touchscreen display can play a vital role in informing a driver about upcoming road obstacles and potential puddle or pothole hazards. Alternative methods can be audio, vibration, lights, and others.

In this regard, the primary vehicle touchscreen 102 can comprise a display screen that serves as both an output display device and an input device for the vehicle computing device 112. This screen can act as an input device for a driver to register puddle or pothole information that may have not been detected by any sensors but instead by visual inspection of the road. The primary vehicle touchscreen 102 can comprise suitable hardware that registers input events in response to touch (e.g., by a finger, stylus, gloved hand, pen, etc.). The type of the primary vehicle touchscreen 102 can vary and can include, but is not limited to, a resistive touchscreen, a surface capacitive touchscreen, a projected capacitive touchscreen, a surface acoustic wave touchscreen, and an infrared touchscreen. In various embodiments, the primary vehicle touchscreen 102 can be positioned on the dashboard of the vehicle, such as on or within the center stack or center console of the dashboard. However, the position of the primary vehicle touchscreen 102 within the automobile 126 can vary.

Other electronic systems/devices 104 can include one or more additional devices and systems (e.g., in addition to the primary vehicle touchscreen 102 and the vehicle computing device 112) of the automobile 126 that can be controlled based at least in part on commands issued by the vehicle computing device 112 (e.g., via the processing unit 122) and/or signals issued by the one or more of the sensory devices 124 communicatively coupled thereto. For example, the other electronic systems/devices 104 can include a media system (e.g., audio and/or video), a complete external and internal sensor system, a heating, ventilation, air-conditioning (HVAC) system, a lighting system, a cruise control system, a power locking system, a navigation system, a self-driving, and the like.

The vehicle computing device 112 can facilitate executing and controlling one or more operations of the vehicle, including one or more operations of the primary vehicle touchscreen 102, and the one or more other electronic systems/devices 104 using machine-executable instructions. In this regard, embodiments of system 100 and other systems described herein can include one or more machine-executable components embodied within one or more machines (e.g., embodied in one or more computer readable storage media associated with one or more machines, such as vehicle computing device 112). Such components, when executed by one or more machines (e.g., processors, computers, computing devices, virtual machines, etc.) can cause one or more machines to perform the operations described.

For example, the vehicle computing device 112 can include or be operatively coupled to at least one memory 120 and at least one processing unit 122. The processing unit 122 can be any of various available processors. Dual microprocessors and other multiprocessor architectures also can be employed as the processing unit 122. In various embodiments, the at least one memory 120 can store computer-executable instructions embodied as software functions/applications that when executed by the at least one processing unit 122, facilitate performance of operations defined by the executable instruction. In the embodiment shown, these computer-executable instructions or software components can include at least an operating system 106. The operating system 106 can act to control and allocate resources of the vehicle computing device 112. It is to be appreciated that the claimed subject matter can be implemented with various operating systems or combinations of operating systems.

These computer-executable instructions or software components can also include an automatic-control unit 108, and one or more other vehicle applications 110. The automatic-control unit 108 and/or the one or more other vehicle applications 110 can take advantage of the management of resources by operating system 106 through program modules and program data also stored in memory 120. The automatic-control unit can perform vehicle actions originating at a sensor device or by computing device 112 that can mitigate or completely avoid potential impact from hazards such as water puddles and potholes. The automatic-control unit 108 can provide various features and functionalities that facilitate the vehicle automatically taking control of various vehicle functions without driver intervention, (e.g., provided by the other electronic systems/devices 104) and applications (e.g., of the one or more other vehicle applications 110) directed by one or more sensor devices 124. For example, the one or more other vehicle applications 110 can vary and include for example, a navigation hazard alert application, a media player application, a phone application, a vehicle settings application, a parking assistance application, an emergency roadside assistance application, and the like.

The vehicle computing device 112 can further include one or more interface ports 114, a communication unit 116, and a system bus 118 that communicatively couples the various components of the vehicle computing device 112 (e.g., the one or more interface ports 114, the communication unit 116, the memory 120 and the processing unit 122). The one or more interface ports 114 can connect the primary vehicle touchscreen 102 (and other potential input devices) and the one or more other electronic systems/devices 104 to the vehicle computing device 112. For example, the one or more interface ports 114 can include, a serial port, a parallel port, a game port, a universal serial bus (USB) and the like.

The communication unit 116 can include suitable hardware and/or software that facilitates connecting one or sensors 124 to the vehicle computing device 112 either via a wireless connection and/or a wired connection. In various embodiments, the communication unit 116 can facilitate establishing a wireless connection with one or more auxiliary devices 124 using one or more networks. Such networks can include wired and wireless networks, including but not limited to, a personal area network (PAN), a local area network (LAN), a cellular network, a wide area network (WAN, e.g., the Internet), and the like. For example, one or more sensor devices 124 can communicate with the vehicle computing device 112 (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), fifth generation partnership project (5G) communication system, third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, near field communication (NFC) technology, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In this regard, the communication unit 116 can include software, hardware, or a combination of software and hardware that is configured to facilitate wired and/or wireless communication between the vehicle computing device 112 and one or more sensor devices 124. While the communication unit 116 is shown for illustrative clarity as a separate unit that is not stored within memory 120, it is to be appreciated that one or more (software) components of the communication unit can be stored in memory 120 and include computer executable components.

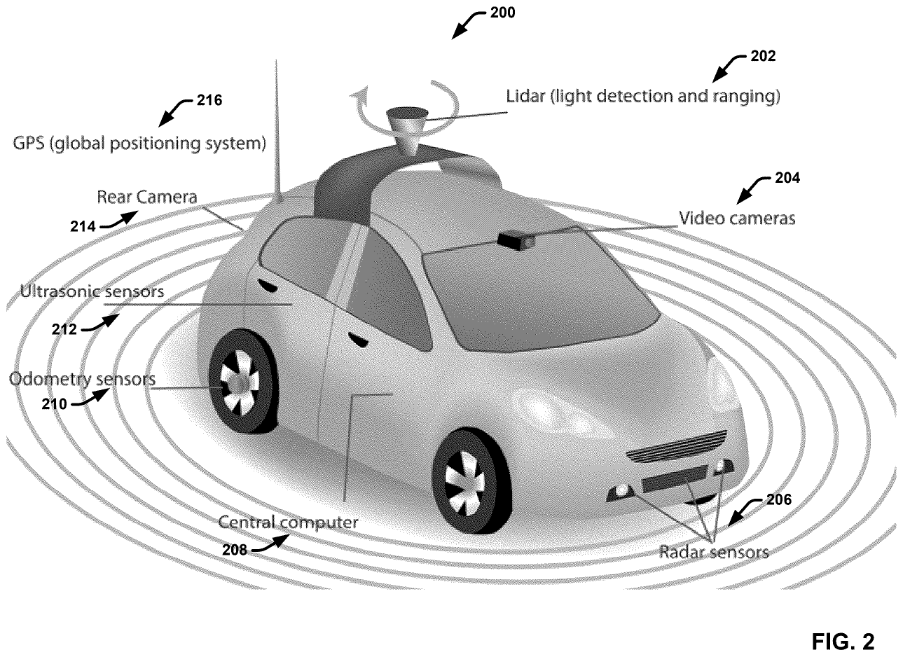

FIG. 2 illustrates a diagram of an example vehicle depicting distinct types of sensors (reflected as 124 in FIG. 1) used in the application in accordance with one or more embodiments described herein. This system will utilize image processing algorithm(s) and machine learning model(s), such as for example image recognition techniques, that use microphones and remote sensing sensors, such as camera, radar, ultrasonic, LiDAR (Light Detection and Ranging), and other similar and evolving technology, to identify water puddles and vulnerable road users such as pedestrians and cyclists.

Cameras, LiDAR radar, and infrared sensors work together to perceive and understand the vehicle's environment. Each sensor type provides unique information about the surroundings, and combining data from multiple sensors allows the vehicle to create a comprehensive understanding of the world around it.

Cameras 204,214 capture visual data of the vehicle's surroundings, including objects, road markings, signs, and other vehicles. Computer vision algorithms analyze camera images to detect and classify objects, recognize lane markings, and interpret traffic signs and signals. Cameras provide high-resolution color images, allowing for detailed visual perception of the environment. Cameras are particularly useful for tasks such as object detection, semantic segmentation, and traffic sign recognition. Camera images can capture the presence of water puddles through visual cues like reflections, color changes, and disruptions in the texture of the road surface.

LiDAR sensors 202 emit laser pulses and measure the time it takes for the pulses to reflect off objects in the environment, creating a 3D point cloud representation of the surroundings. LiDAR provides precise distance measurements to objects, enabling accurate localization and mapping. LiDAR is effective in detecting and localizing objects in all lighting conditions, including darkness and adverse weather. LiDAR is particularly useful for tasks such as obstacle detection, localization, and mapping, especially in environments with complex geometry. LIDAR can be used to create a depth map of the road surface, identifying potholes and depressions filled with water.

Radar sensors 206 emit radio waves and measure the time it takes for the waves to reflect off objects, providing information about the distance, velocity, and angle of objects in the environment. Radar is capable of detecting objects at long ranges and through various weather conditions, including rain, fog, and snow. Radar is particularly useful for detecting moving objects such as vehicles and pedestrians and for providing velocity information. Radar is often used for tasks such as adaptive cruise control, collision avoidance, and blind-spot detection. Radar signals can be reflected differently by water than by the road, providing another layer of data.

Ultrasound sensors 212 measure the Time of Flight (ToF) of sonic waves to calculate the distance to an object or reflector within the measuring range. Car ultrasonic sensors are essential components in Advanced Driver Assistance Systems (ADAS), primarily used for parking guidance, blind spot detection, and object avoidance. These sensors utilize high-frequency sound waves to gauge the distance between objects within close range, providing valuable data for various applications such as urban parking solutions, autonomous vehicles, and Vehicle-to-Everything (V2X) technology. These sensors can measure the distance to the road surface, detecting changes that might indicate puddles.

Odometry sensors 210 use the data from motion sensors to monitor the change of position over time. This particular sensor is linked with position sensors but focuses on the change of position. It is commonly used in robotics to estimate the position change from the starting point to the endpoint. However, it is now incorporated in many autonomous vehicles to keep track of the position of the vehicle from a specific location.

The GPS (Global Positioning System) 216 is frequently used by autonomous vehicles to help them with navigation and give them positioning data. These systems use data received from several GPS satellites. With the current navigation technology, vehicles are incorporating these systems to create routes, analyze traffic, and possess information about the position of the vehicle in real time, also this can include the GPS capturing all the weather-related and road data the system needs, along with any news updates. This can be connected with major sensors for autonomous vehicles in order to create an innovative navigation experience without human interaction. GPS connects with the Global Navigational Satellite System (GNSS) which gives more data to the vehicle that guarantees the actual position. This technology is mostly used for ground vehicles that are constantly on the road surrounded by other cars and pedestrians. GPS data can also provide information about known trouble spots for water accumulation.

By integrating data from cameras, LiDAR, radar, and infrared sensors (cooler areas on the road can be detected by thermal cameras), which may indicate the presence of water puddle, systems can create a comprehensive understanding of the vehicle's surroundings, enabling safe and efficient navigation in diverse and challenging environments—this is very important in puddle detection. Each sensor type has its strengths and limitations, and combining multiple sensor modalities allows vehicles to perceive the environment from different perspectives and mitigate the shortcomings of individual sensors.

Microphones (not depicted on the figure as they can be mounted throughout the circumference of the vehicle or selected prime locations) can be used in driving systems to complement other sensors by capturing audio information from the vehicle's surroundings. While microphones may not be as commonly utilized as cameras, LiDAR, radar, or infrared sensors, they can provide valuable supplementary data for certain applications.

Microphones enable environmental sound analysis because they capture sounds from the vehicle's surroundings, including engine noise, tire squeals, honking, sirens, and other environmental sounds. Analyzing these sounds can provide additional context about the driving environment and help the vehicle understand its surroundings better.

Collision Detection and Identification can happen with microphones as they can detect sounds associated with collisions or accidents, such as the sound of a collision impact or the screeching of tires. By analyzing these sounds, the vehicle can potentially detect and respond to nearby collisions or accidents, either by taking evasive action or by notifying the driver or emergency services.

Pedestrian detection is also possible with microphones. Microphones can detect sounds made by pedestrians, such as footsteps, voices, or bicycle bells. By analyzing these sounds, the vehicle can potentially detect the presence of pedestrians or cyclists in its vicinity, especially in situations where visual detection may be challenging, such as in low light or poor visibility conditions.

Noise filtering and signal processing techniques may be necessary to extract useful information from audio recordings made by vehicle microphones while filtering out background noise and other irrelevant sounds.

Real world data as obtained through microphones and remote sensing sensors, such as camera, radar, infrared, LiDAR is ingested by an advanced algorithm such as a machine learning algorithm in the vehicle central computer (100,208) to detect puddles for splash avoidance. This will enable a driver alert or automatic precautionary measures such as controlled braking inputs.

System 100 can utilize the various sensors alone or in any suitable combination, e.g., as a function of extrinsic information and conditions, applying variable weighting to respective sensors as a function of utility given current or inferred future context. For example, in certain conditions such as fog, a radar system will have greater utility than cameras. Likewise, in a GPS shadow, a GPS system will have lower utility than cameras. System 100 can also group respective sensing modalities to gain optimized utility for a given set of sensors for a set of conditions. Probabilistic utility-based analyses can be performed to determine or infer the benefit of taking correct action relative to cost of taking an incorrect action. Other factors include using acoustic data where the sound profile of the vehicle's interaction with the road can change when driving through water. Vehicle dynamics information from the ego and the surrounding vehicle's stability control and anti-lock braking systems can indicate loss of traction consistent with puddle encounters. Even the time of day as lighting conditions can affect the visibility of puddles and may be a relevant feature, this would have to be coordinated with light detection.

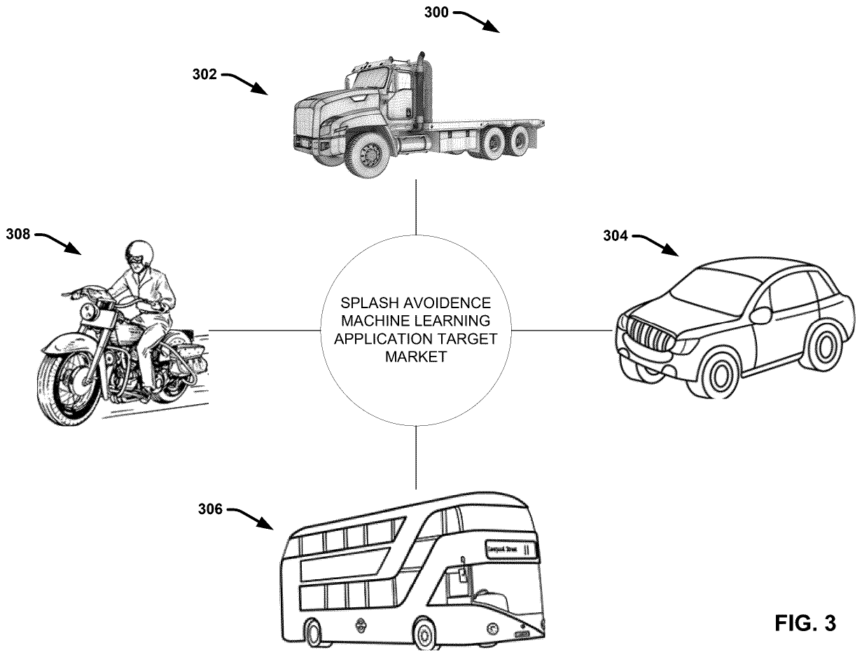

FIG. 3 illustrates a diagram of various transportation entities that can use splash mitigating or avoidance features in accordance with one or more embodiments described herein. It should be noted that this innovation is not limited to automobiles but can apply to any suitable vehicle type that has tires or any intrusive element that may impact a puddle or pothole that could lead to adverse consequences for a pedestrian/cyclist or even driver. Standard vehicles 304 with any number of wheels are a primary threat to pedestrian(s) as they encompass the vast majority of transportation vehicles on the road. These vehicles are very capable of supporting splash mitigating embodiments due to relatively ubiquitous technology and electronics currently available. Automobiles currently possess a vast number of sensors which will increase in number and functionality as autonomous vehicles prosper. The same features can be implemented for many trucks and buses, this can be just as significant because the impact of a splash driven from a bus 306 or truck 302 can be of higher magnitude with greater negative consequences than from a typical car. Trucks can carry expensive payloads which are exposed to damage if the truck skids or changes direction due to a puddle or pothole. Busses carry a high volume of passengers that can also be subject to risk due to skidding or redirection based on a puddle or pothole. Motorcycles 308 currently do not carry the same level of sensors contained in an automobile but can be potentially enhanced to provide similar capabilities. Visual inspection of a road along with audio feedback from a cloud-based server can greatly improve the safety of a rider along with pedestrian(s) or cyclist(s). The subject splash mitigation innovation(s) can also be implemented throughout various regions of the globe—for instance rickshaws in the far cast that contain minimal communication devices can still be capable of enhancements. Global geographical servers can contain hazard data from most every road traveled and maintain a database for any suitable transportation vehicle to access.

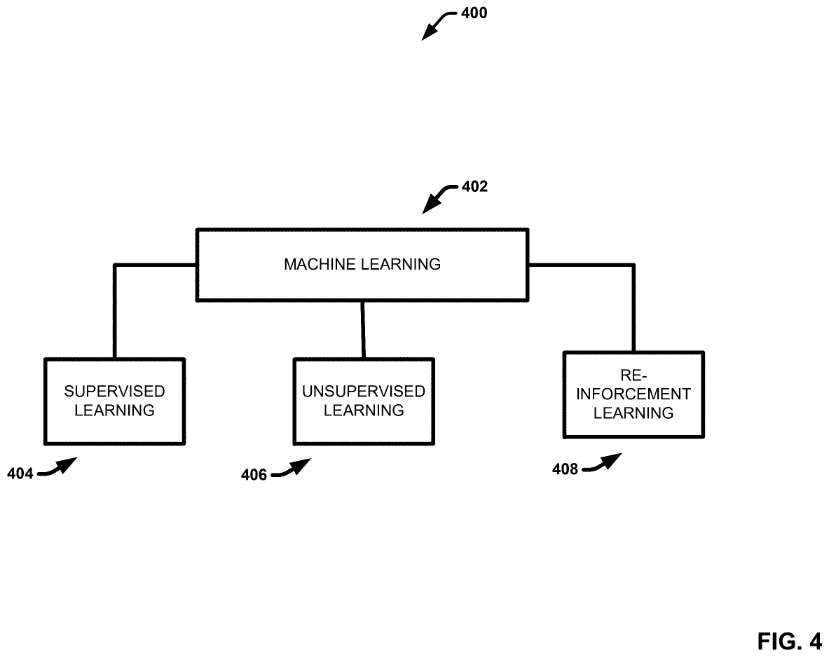

FIG. 4 presents a diagram of the distinct types of machine learning methods that can be used for this application in accordance with one or more embodiments described herein. Machine learning 402 is a subset of artificial intelligence (AI) that focuses on development of algorithms and statistical models that enable computers to learn and make predictions or decisions based on data without being explicitly programmed to do so. In essence, machine learning algorithms learn from patterns and relationships within the data to improve performance over time. For embodiments described herein there are many options such as DNN (Deep neural networks). Deep neural networks (DNNs) are a class of artificial neural networks that are specifically designed to handle complex and high-dimensional data. They are a form of machine learning algorithms that have significantly advanced the field of artificial intelligence (AI) in recent years.

Machine learning can be broadly categorized into three main types based on the learning approach used: supervised learning 404, unsupervised learning 406, and reinforcement learning 408. These three types of machine learning represent different approaches to learning from data and solving distinct types of problems. Many real-world applications may involve a combination of these approaches or use techniques from one type to complement those of another.

In supervised learning, the algorithm is trained on a labeled dataset, where each input data point is associated with a corresponding target or label. The goal of supervised learning is to learn mapping from input features to output labels, based on the patterns and relationships present in the labeled training data. Supervised learning tasks include classification, where the goal is to predict a categorical label for each input data point, and regression, where the goal is to predict a continuous value for each input data point. Common algorithms used in supervised learning include linear regression, logistic regression, decision trees, random forests, support vector machines (SVM), and neural networks.

In unsupervised learning, the algorithm is trained on an unlabeled dataset, where no explicit labels or targets are provided. The goal of unsupervised learning is to discover patterns, relationships, and structure within the data without the guidance of labeled examples. Unsupervised learning tasks include clustering, where the goal is to partition the data into groups or clusters based on similarity, and dimensionality reduction, where the goal is to reduce the number of features in the data while preserving valuable information. Common algorithms used in unsupervised learning include k-means clustering, hierarchical clustering, principal component analysis (PCA), and autoencoders.

In reinforcement learning, the algorithm learns through interaction with an environment by taking actions and receiving feedback in the form of rewards or penalties. The goal of reinforcement learning is to learn a policy or strategy that maximizes cumulative rewards over time by exploring different actions and learning from their outcomes. Reinforcement learning tasks include learning to play games, robotic control, autonomous driving, and optimizing business processes. Common algorithms used in reinforcement learning include Q-learning, deep Q-networks (DQN), policy gradient methods, and actor-critic methods. For this innovation, reinforcement learning to train the model for self-correction can be considered. In embodiments where for example reinforcement learning is utilized, it is to be appreciated that a probabilistic-based assessment relating to operation of a vehicle can be a policy.

The choice of machine learning model depends on several factors, including the nature of the data, the task at hand, computational resources, and interpretability requirements. However, some machine learning models are commonly used across different applications due to their versatility and effectiveness. Examples of commonly used machine learning models include linear regression, logistic regression, decision trees, random forests, support vector machines, K-nearest neighbors, and neural networks.

Linear regression is a simple, yet powerful model used for predicting a continuous target variable based on one or more input features. It assumes a linear relationship between the input features and the target variable and seeks to find the best-fitting line or hyperplane that minimizes the difference between the predicted and actual values.

Logistic regression is a binary classification model used for predicting the probability that an input belongs to a particular class. It models the relationship between the input features and the binary outcome using the logistic function, which maps the input values to probabilities between 0 and 1.

Decision trees are versatile models used for both classification and regression tasks. They partition the feature space into a series of hierarchical decisions based on the values of input features, ultimately leading to a prediction at the leaf nodes of the tree.

Random forests are an ensemble learning method that combines multiple decision trees to improve predictive performance and reduce overfitting. They build multiple decision trees on bootstrapped samples of the training data and aggregate their predictions to make more robust predictions.

Support vector machines are powerful models used for classification and regression tasks. They find the optimal hyperplane that separates the data into different classes or predicts continuous values, while maximizing the margin between the classes.

K-nearest neighbors is a simple and intuitive model used for classification and regression tasks. It makes predictions by finding the majority class or averaging the values of the k nearest data points in the feature space.

Neural networks are highly flexible models inspired by the structure and function of the human brain. They consist of interconnected layers of neurons that learn complex patterns and relationships in the data through a process called backpropagation.

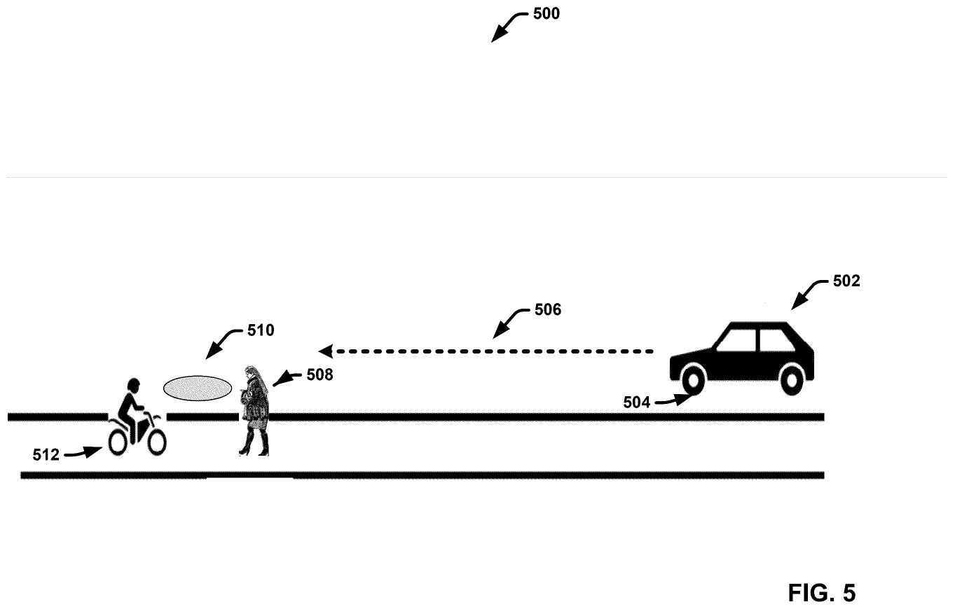

FIG. 5 presents an illustration of an example scenario in which features can be implemented in accordance with one or more embodiments described herein. A vehicle system 502 scans a road (using sensors previously mentioned) continuously or less frequently based on information from weather forecast(s) and recent historic data. For example, if there has been no recent rain in that region according to the latest weather information, there is less need to scan the road for water puddles. Data received can also include up to date news such as recent flooding or water main leaks or something similar that may impact the analysis.

Upon identifying a water puddle 510 utilizing sensor data, the system 502 scans for cyclists 512 or pedestrians 508 in vicinity of an identified water puddle 510. Also, the system 502 can gather information from both recent and forecasted weather conditions along with relevant news updates to assess likelihood and liability of the identified water puddle 510. For instance, it is more likely to find a water puddle if there has been recent rain in that region. It should be noted as the vehicle continues to traverse in its journey, potholes can also be identified (with or without water fill) and stored for future use to indicate potential hazardous terrain for the vehicle or other vehicles that can gather data from this vehicle.

System 502 can potentially estimate time 506 in which the vehicle and identified pedestrians or cyclists will reach a location. System 502 can also have information regarding tire pattern 504 (e.g., depth, tread, winter/summer, etc.) to facilitate assessing potential magnitude of a splash to pedestrian/cyclist incident. The system 502 can also estimate risk of water splashing at the identified location based on previous parameters. For example, if there is no pedestrian/cyclist, there is negligible risk of harming a pedestrian/cyclist with potential water splashing. The algorithms estimate the risk of splashing based on several parameters such as distance to the puddle: the closer the vehicle to the puddle to higher the risk. Puddle size and depth: larger and deeper puddles are more likely to cause significant splashes. Vehicle speed: the higher the speed the higher the risk of a more significant splash. Proximity of road vulnerable users: the closer they are to the puddle the higher the higher the risk of they impacted by the splash. Tire profile is an aspect of this innovation with respect to preventing splashing, depth and pattern of a tire tread can impact magnitude of a splash. Some tire profiles can make a stronger splash than other tire profiles.

In one scenario, system 502 can provide a driver with early notifications, e.g., via a touch screen display (infotainment system) or even an audio or vibration alert regarding risk of splashing, enabling the driver to take necessary actions well in advance. This proactive alert can facilitate the driver to respond promptly, avoiding panic behaviors such as sudden braking or abrupt maneuvers. In another scenario, which can also be the case for autonomous vehicles, system 502 can automatically handle a risky impact situation by early deceleration to avoid splashing. Additionally, system 502 can perform a small maneuver to avoid splashing if the ML method deems it will achieve the best outcome.

The location of the identified water puddle or pothole can be stored in a database and can be shared with other vehicles that do not have this function to identify the water puddles. After passing the water puddle, the vehicle can continue normal driving.

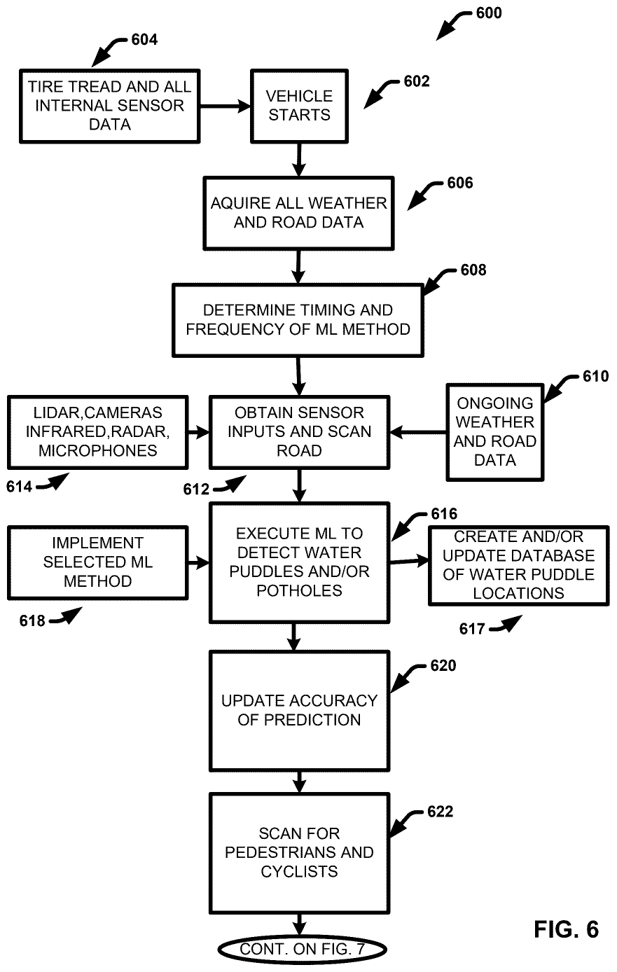

FIG. 6 illustrates part 1 of a flow diagram for various features shown as a sequence of events in accordance with one or more embodiments described herein. As a vehicle is started 602, tire data 604 (size, wear, depth, miles driven, etc.) is provided to a vehicle computer and can change as the vehicle continues its journey. At this point, GPS can provide relevant road and weather data 606 that relates to route the vehicle may be configured. If there is no selected destination, the weather can be provided for the route in progress and upcoming potential routes as the vehicle progresses. As the vehicle progresses, frequency 608 that runs a ML process will be determined—for example if weather is rainy and the street is known to have potential puddles or potholes, the ML process can be executed at a higher frequency to help guide the vehicle. If a water puddle is detected, the scan can automatically adjust to a maximum frequency as there is a greater chance of other puddles. If the weather is sunny and the road is determined to be a low splash or no pothole zone (from previous database information), the ML process may run much at lower relative frequency. These are just examples as there can be a constant frequency option(s) within configuration. It is significant to note that the vehicle has the capability to continuously scan roads and gather weather and road data (610, 612, and 614) whether the ML process is running or not. It is the signals from these inputs that can trigger the ML process to initiate. Based on a specific signal or a set of signals the ML process is activated; this can be any type of machine learning method 618. The ML method is then executed 616 to detect possible puddles and potential potholes, then there is an update of the accuracy of the prediction 620. For this innovation, a machine learning or a deep neural network such as Fully Convolutional Neural Network (F-CNN) or Region-Based Convolutional Neural Network (R-CNN) or You Only Look Once (YOLO) can be used to identify the water puddle and/or potholes. This can be done by processing and learning from the large datasets of vehicle sensor data and identifying the relevant features and patterns. Training the neural networks can be done using data collection and preprocessing as in gathering a large dataset of labeled sensor data under various conditions. Model training can use the preprocessed data to train the neural network, adjusting weights to minimize the loss function. Testing the model on a separate dataset to ensure it generalizes well to new data can be validated. For adjustments, fine-tuning can be implemented which can be adjusting hyperparameters or adding more data to improve performance as needed.

In addition to the offline training and validation, an ML model can improve its performance by real-time verifying the identified water puddles or potholes, this can be called a Post-Identification Verification. This module would use the following to do the real-time verification:
Suspension Data: As the vehicle drives over the puddle, the suspension system registers the impact. This data can be used to verify the depth and size of the puddle.
Acoustic Sensors: The sound of the vehicle's tires splashing through water provides auditory confirmation of a water puddle.
Vehicle Dynamic Sensors: Information from the vehicle's stability control and anti-lock braking systems can indicate loss of traction consistent with puddle encounters.
Vehicle Trajectory and Acceleration: If the vehicle's trajectory or speed changes by the driver at the identified water puddle location (e.g., slight swerving or slowing down), it can indicate the presence of a puddle.
External Verification: Observing the behavior of other vehicles as they interact with the puddle can provide additional verification data.

Using this data the neural network can continuously verify and improve its water puddle identification capabilities, leading to a more reliable and robust system for enhancing vehicle and pedestrian/cyclist safety.

When the ML model detects a potential water puddle using the sensor data, the system can use the weather data and also input from other sources such as news and social media (e.g., water leakage) to validate and cross reference the model findings. If puddles are located, a temporary database is created or updated with puddle locations 617. If the weather data and other data sources do not support the presence of a water puddle (e.g., no recent rain or no water leakage), the system may flag the sensor reading for further review or adjust the reliability of such prediction. At this point, a ML model initiates searching (this can be same ML model or a different one as there can be a specific model utilized for specific functions) for pedestrians or cyclists 622 that may be adversely impacted by a puddle or pothole. A ML model (possibly the same or a different model) can combine the sensor data searching for puddles with the pedestrian scan data to infer or determine time to impact with a puddle and potential splashing of a pedestrian. A utility-based analysis can be performed to factor benefit of taking action (e.g., swerving, braking, riding through puddle) against cost of taking incorrect action, For example, swerving to avoid the puddle and not splash a pedestrian has benefit, but potentially at the cost of causing an accident.

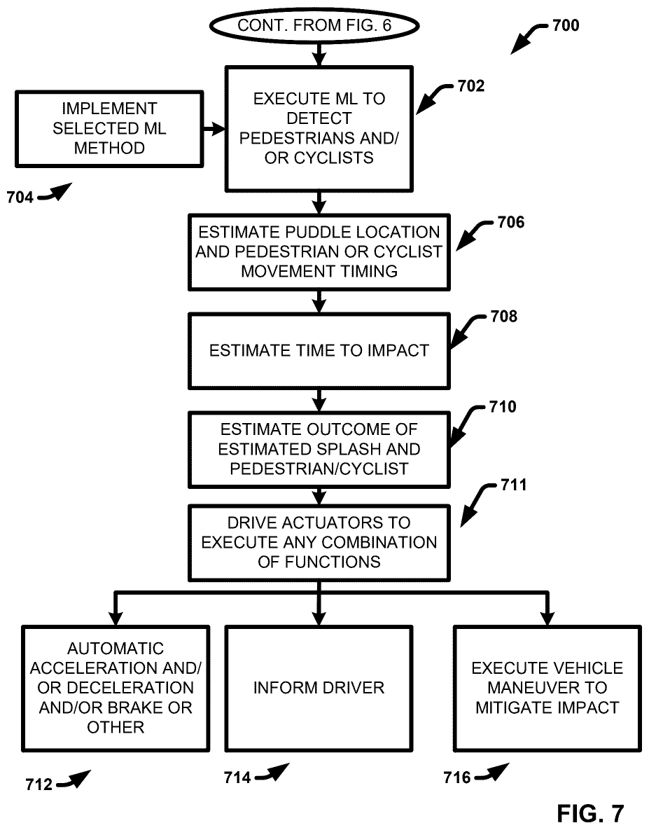

FIG. 7 illustrates part 2 of a flow diagram for this application shown as a sequence of events in accordance with one or more embodiments described herein. Again, a selected ML method is implemented 704 and is executed 702 to detect pedestrians or cyclists from scans. The splash mitigating impact process will then estimate puddle location and pedestrian or cyclist timing to determine potential outcomes. The system will proceed to estimate time to impact 708 defined as time the pedestrian or cyclist are within a splash zone. A ML process (this can be same ML model or a different one as there can be a specific model utilized for specific functions) will take into account multiple sets of data such as vehicle speed, sensors, pedestrian or cyclist speed, puddle depth, puddle volume, potential pothole identifications and any other data that can impact the pedestrian/cyclist. Even if there is no puddle identified, a potential pothole may re-direct the vehicle towards a pedestrian. The goal is to minimize or completely avert negative impact to the pedestrian or cyclist. Using this data, a ML model or other mechanism (this can be same ML model or a different one as there can be a specific model utilized for specific functions) will decide estimated outcome 710 based on processing multiple possible scenarios with the splash and pedestrian interaction and determine an optimum probability-based outcome. For more details, upon detecting the water puddles on the road, the system simultaneously detects pedestrians/cyclists on the road. Then it estimates the time of impact by considering the speed, direction of the ego vehicle as well as cyclist/pedestrians. Then the algorithms estimate the risk of splashing based on several parameters. The distance to the puddle, the closer the vehicle to the puddle the higher the risk. Puddle size and depth as larger and deeper puddles are more likely to cause significant splashes. Vehicle speed as the higher the speed the higher risk of more significant splash. The proximity of road vulnerable users as the closer they are to the puddle the higher the higher the risk of they impacted by the splash. Tire profile is a key factor in preventing splashing, the depth and pattern of the tire tread affects the significance of the splash. Some tire profiles can make a stronger splash. Weather conditions as the rainy weather conditions the higher risk of splashing. Historical Data Integration is also used as the system uses historical data to understand how similar tire and road conditions have led to splash events in the past, refining the risk assessment process. The algorithm combines these parameters to calculate a risk score, which determines the likelihood of a splash event affecting nearby pedestrians or cyclists. If the risk score exceeds a certain threshold, the system can take preventive actions such as deceleration, changing the trajectory, and braking, etc. identified by the Control Unit Module which potentially can be controlled by a reinforcement learning algorithm.

The tire profile is especially important here as it can be primarily used to assess the required action of the car/driver. After the ML algorithm is executed, the optimum outcome determined by the ML is then implemented by actuators that will drive 711 three different options. A ML method can inform the driver through the infotainment system and/or a dashboard visual touch screen with a video or audio signal informing the driver a recommended action 714. Another option is the vehicle automatically (without driver intervention) brakes or accelerates/decelerates 712 to minimize or completely avoid the splash impact. The third option is that ML process will take command of the vehicle 716 and maneuver it as directed by the optimum outcome—this would be the outcome for automatically driverless vehicles along with any vehicle in which the driver has dis-engaged from control. These options can be identified by the control unit module which can be potentially controlled by a policy obtained by a DRL (deep reinforcement learning).

The following describes one example of a potential deep reinforcement learning (DRL) model that controls the vehicle actions.
State Space(S): Represents the environmental states, including but not limited to the road condition, the size, depth, and location of the puddle, current and historical weather conditions, presence, and speed and trajectory of the pedestrian or cyclist, presence, and locations of other vehicles, as well as the current location and features (acceleration, speed, tire profile, etc.) of the ego car, etc.
Action Space (A): Consists of possible actions such as informing the driver, adjusting the path to avoid the puddle, acceleration, deceleration, maintain the trajectory, etc.
Reward Function: The reward function is designed to prioritize safety and comfort. It assigns high positive rewards for actions that avoid puddles without compromising the safety of pedestrians and cyclists, and negative rewards for unsafe maneuvers or discomfort caused. The reward function could be expressed as:

$$R ( S , A ) = \{ \begin{matrix}+ r & if puddle avoided safetly \\ - r & if pedestrian or cyclist safety compromised \\ 0 & otherwise\end{matrix}$$

Policy and Value Functions: The policy function determines the best action to take in a given state, while the value function estimates the expected return of taking an action in a state. DRL uses deep neural networks to approximate these functions, allowing the system to handle complex, high-dimensional state spaces.
Training and Learning: The vehicle's DRL system can be trained through simulation and real-world trials. It uses the collected data to update the policy and value functions, improving its decision-making over time. The DRL algorithm can be implemented in a control unit which receives information from variety of sensors and is connected to sets of actuators that performs necessary actions. By observing the current state(S), selecting an action (A) from the action space that maximizes the expected reward, and then receiving a reward based on the outcome. The algorithm learns the optimal policy by continuously updating its action-value function, which estimates the expected return of taking an action in a given state.

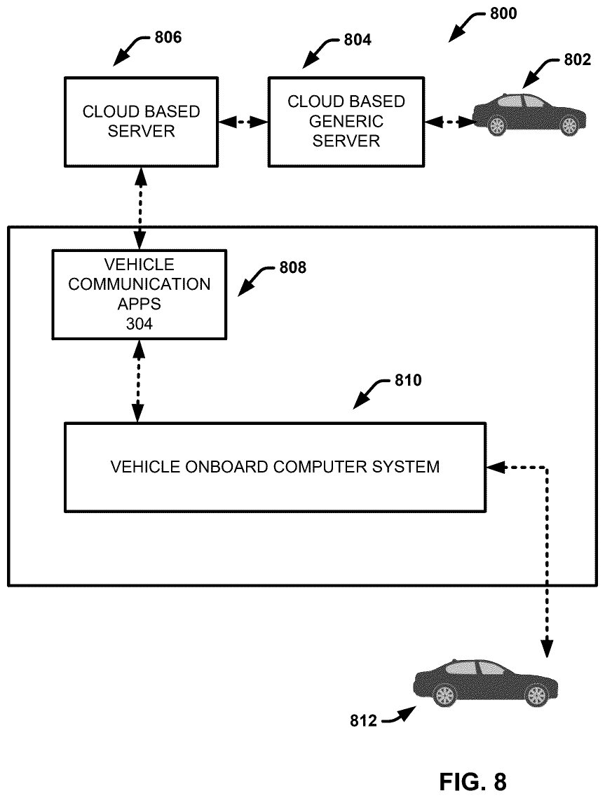

FIG. 8 illustrates a communication diagram for vehicle-to-vehicle data transmission supporting multiple vehicles in accordance with one or more embodiments described herein. Discussing the content related to vehicle data transfer referred to in FIG. 5, there can be multiple single or bi-directional communication paths that can be used for vehicle-to-vehicle data. This communication can be implemented on command, during or after a specific event or at a specified data transfer rate identified in configuration. Vehicles can communicate with another vehicle using cloud-based servers, the process typically involves a combination of mobile applications, internet connectivity, and backend systems. As an example scenario, assume vehicle 812 has driven through or past certain puddles or potholes that were identified by the vehicle's sensors. The vehicle has stored this data temporarily in its onboard computing system 810 as depicted in FIG. 8 and is configured to send this data to vehicle 802. Component 810 can contain an internal framework which can be data storage, a mechanism to process data, and the primary communication portal to the vehicle.

When a vehicle interacts with another vehicle a vehicle communication application 808 can perform actions such as transferring data (can be real time or delayed) to another vehicle and also potentially receive data from a vehicle. The vehicle communication application 808 sends encrypted commands to a cloud-based server 806 and possibly multiple cloud-based servers if required to facilitate the transfer. Any associated permissions can be stored and managed on cloud-based servers maintained by the vehicle manufacturer or a related service provider if required. The server 806 can authenticate the user and verify the permissions associated with this data transfer. This server 806 can also handle authentication, authorization, and encryption of communication between vehicles. From the cloud-based server 806, the data can be transferred to various other servers as mentioned. This could be to a proprietary OEM server 804 to support other vehicles of the same brand or possibly a generic server 804 that can contain the puddle/pothole and other information to support vehicles of any brand. Both vehicles need to have internet connectivity to communicate with the cloud-based servers. This can be achieved through Wi-Fi, cellular data connections (e.g., 4G/5G), or a combination of both.

Once the cloud-based servers authenticate the user and authorize the requested action, typically the servers involved can send encrypted message data to a similar communication application within the target vehicle to process the data via a secure communication channel. This communication may involve protocols such as HTTPS (HTTP Secure) or MQTT (Message Queuing Telemetry Transport) to ensure data integrity and confidentiality. Feedback may be sent back to the cloud servers to confirm the successful execution of the data transfer.

By leveraging cloud-based infrastructure, vehicle data transfer can offer enhanced functionality, flexibility, and security. Users can also remotely manage access to their data and monitor their status along with potential landscape problems such as high-risk puddle or pothole zones using a mobile device. To support these applications, manufacturers can implement advanced security measures and quickly deploy updates or patches to address potential vulnerabilities.

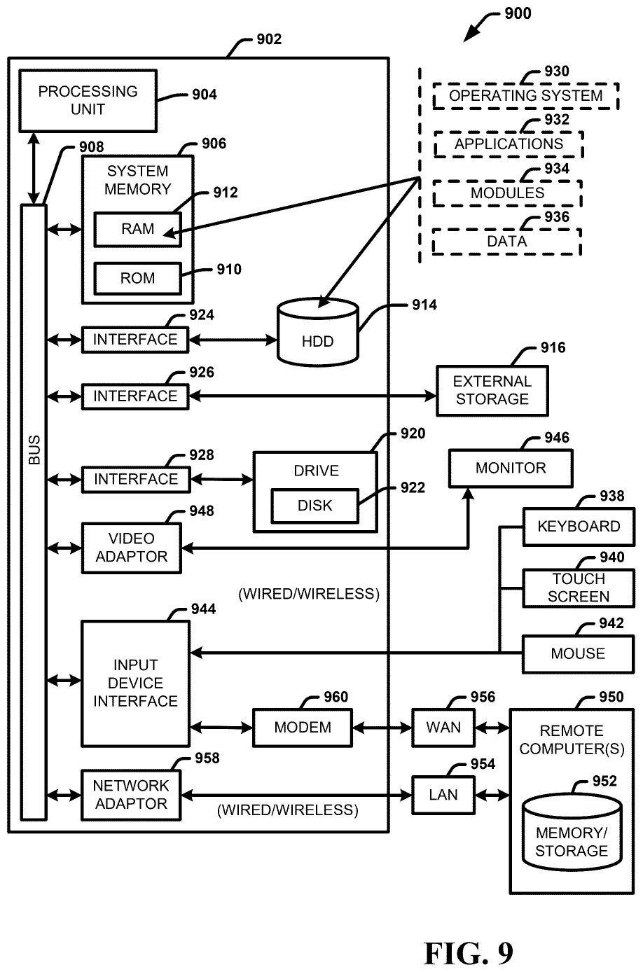

With reference to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. System memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 1012 can also include high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and a drive 920, e.g., such as a solid state drive, an optical disk drive, which can read or write from a disk 922, such as a CD-ROM disc, a DVD, a BD, etc. Alternatively, where a solid-state drive is involved, disk 922 would not be included, unless separate. While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and drive 920 can be connected to the system bus 908 by an HDD interface 924, an external storage interface 926 and a drive interface 928, respectively. The interface 924 for external drive implementations can include at least one or both Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

The computer 902 can operate in a networked environment using logical connections via wireless communications based GPRS, GSM, 5G, LTE, 6G protocols.

When used in a LAN networking environment, the computer 902 can be connected to the local network 954 through a wired or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above, such as but not limited to a network virtual machine providing one or more aspects of storage or processing of information. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

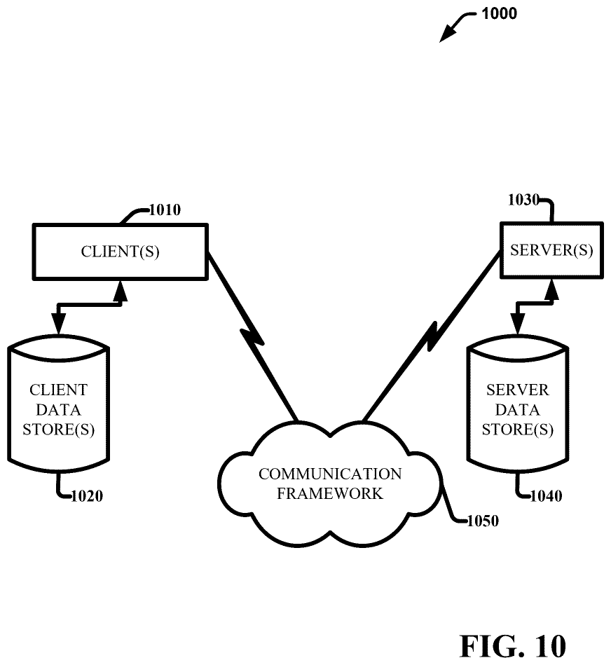

FIG. 10 is a schematic block diagram of a sample computing environment 1000 with which the disclosed subject matter can interact. The sample computing environment 1000 includes one or more client(s) 1010. The client(s) 1010 can be hardware or software (e.g., threads, processes, computing devices). The sample computing environment 1000 also includes one or more server(s) 1030. The server(s) 1030 can also be hardware or software (e.g., threads, processes, computing devices). The servers 1030 can house threads to perform transformations by employing one or more embodiments as described herein, for example. One possible communication between a client 1010 and a server 1030 can be in the form of a data packet adapted to be transmitted between two or more computer processes. The sample computing environment 1000 includes a communication framework 1050 that can be employed to facilitate communications between the client(s) 1010 and the server(s) 1030. The client(s) 1010 are operably connected to one or more client data store(s) 1020 that can be employed to store information local to the client(s) 1010. Similarly, the server(s) 1030 are operably connected to one or more server data store(s) 1040 that can be employed to store information local to the servers 1030.

The present invention may be a system, a method, an apparatus, or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches, and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above includes mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

One or more embodiments of the present invention may be a system, a method, an apparatus, and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Various aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches, and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. Additionally, the disclosed memory components of systems or computer-implemented methods herein are intended to include, without being limited to including, these and any other suitable types of memory.

What has been described above includes mere examples of systems and computer-implemented methods. It is, of course, not possible to describe every conceivable combination of components or computer-implemented methods for purposes of describing one or more embodiments, but one of ordinary skill in the art can recognize that many further combinations and permutations of these embodiments are possible. The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The terminology used herein was chosen to best explain the principles of the embodiments, the practical application or technical improvement over technologies found in the marketplace, or to enable others of ordinary skill in the art to understand the embodiments disclosed herein. In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various non-limiting aspects of various embodiments described herein are presented in the following clauses.

1. A system of a vehicle, comprising: a processor; and a memory communicatively coupled to the processor, the memory having stored therein computer-executable instructions, comprising: a receiving component that receives vehicle environment data from a set of sensors along with current or historical weather data; and a machine learning component configured to train a model which that learns from vehicle environment, current or historical weather data, vehicle tire attributes, vehicle weight, vehicle speed, determined or inferred puddles and possibly other acquired data, and generates a probabilistic-based assessment relating to operation of the vehicle; and an execution component that, based on the assessment provided by the trained model, generates a course of actions mitigating splashing of road users in proximity to the vehicle.

2. The system of any preceding clause, wherein the execution component is configured to utilize the trained model to apply the generated course of actions.

3. The system of any preceding clause, wherein at least one of the set of sensors facilitates identifying water puddles on or adjacent to a road.

4. The system of any preceding clause, wherein the set of sensors comprises at least one camera, and wherein the system is configured to identify an individual within proximity to the vehicle based on input from at least one camera.

5. The system of any preceding clause, further comprising a notification component that notifies a driver of the vehicle of potential of splashing the individual.

6. The system of any preceding clause, wherein the system utilizes image processing and/or a machine learning process to identify the water puddles and then based on the current or historical weather data, the probability of a correctly identified water puddle is assessed.

7. The system of any preceding clause, wherein the system utilizes information regarding current or historical weather conditions with a tire profile of the vehicle in connection with prediction of a splash by the vehicle.

8. The system of any preceding clause, wherein the system stores locations of identified water puddles in a database for utilization by other vehicles.

9. The system of any preceding clause, wherein the system is configured to estimate risk or magnitude of splashing based on at least one of: distance to a puddle: puddle size and depth; vehicle speed; proximity of road vulnerable users; or vehicle attributes.

10. The system of any preceding clause, wherein the machine learning component is configured to use reinforcement learning to generate the probabilistic-based assessment relating to operation of the vehicle.

11. A computer-implemented method comprising, receiving by a system of a vehicle, vehicle environment data from a set of sensors along with current or historical weather data; configuring by the system machine learning to train a model which that learns from vehicle environment, current or historical weather data, vehicle tire attributes, vehicle weight, vehicle speed, determined or inferred puddles and possibly other acquired data, and generates a probabilistic-based assessment relating to operation of the vehicle; and executing by the system, based on the assessment provided by the trained model, a course of actions mitigating splashing of road users in proximity to the vehicle.

12. The method of any preceding clause, further executing by the system that is configurable to execute a method to utilize the trained model to apply the generated course of actions.

13. The system of any preceding clause, further comprising utilizing at least one of the set of sensors and the ML model to facilitate identifying water puddles and potholes on or adjacent to a road.

14. The system of any preceding clause, further comprising a set of sensors with at least one camera, and wherein the system is configured to identify an individual within proximity to the vehicle based on input from at least one camera.

15. The system of any preceding clause, further comprising notifying by the system, a driver of the vehicle of potential of splashing the individual.

16. The system of any preceding clause, further comprising utilizing, by the system, image processing and/or machine learning to identify the water puddles and then based on the current or historical weather data, probability of a correctly identified water puddle is assessed.

17. The system of any preceding clause, further comprising by the system, utilization of information regarding current or historical weather conditions with a tire profile of the vehicle in connection with prediction of a splash by the vehicle.

18. The system of any preceding clause, further comprising storing by the system, locations of identified water puddles in a database for utilization by other vehicles.

19. The system of any preceding clause, further comprising estimating, by the system, risk or magnitude of splashing based on at least one of: distance to a puddle: puddle size and depth; vehicle speed; tire profile; proximity of road vulnerable users; or vehicle attributes

20. The system of any preceding clause, further comprising utilizing, by the system, reinforcement learning to generate the probabilistic-based assessment relating to operation of the vehicle.

Any suitable combination of clauses 1 through 10.

Any suitable combination of claims 11-20.

What is claimed is:

1. A system of a vehicle, comprising:
a processor; and
a memory communicatively coupled to the processor, the memory having stored therein computer-executable components, comprising:
a receiving component that receives vehicle environment data from a set of sensors along with current or historical weather data; and
a machine learning component configured to train a model which that learns from vehicle environment, current or historical weather data, vehicle tire attributes, vehicle weight, vehicle speed, determined or inferred puddles and possibly other acquired data, and generates a probabilistic-based assessment relating to operation of the vehicle; and
an execution component that, based on the assessment provided by the trained model, generates a course of actions mitigating splashing of road users in proximity to the vehicle.

2. The system of claim 1, wherein the execution component is configurable to execute a method to utilize the trained model to apply the generated course of actions.

3. The system of claim 1, wherein at least one of the set of sensors and the ML model to facilitate identifying water puddles and potholes on or adjacent to a road.

4. The system of claim 3, wherein the set of sensors comprises at least one camera, and wherein the system is configured to identify an individual within proximity to the vehicle based on input from at least one camera.

5. The system of claim 4, further comprising a notification component that notifies a driver of the vehicle of potential of splashing the individual.

6. The system of claim 1 wherein the system utilizes image processing and/or a machine learning process to identify the water puddles and then based on the current or historical weather data, the probability of a correctly identified water puddle is assessed.

7. The system of claim 1, wherein the system utilizes information regarding current or historical weather conditions with a tire profile of the vehicle in connection with prediction of a splash by the vehicle.

8. The system of claim 1, wherein the system stores locations of identified water puddles in a database for utilization by other vehicles.

9. The system of claim 1, wherein the system is configured to estimate risk or magnitude of splashing based on at least one of: distance to a puddle: puddle size and depth; vehicle speed; tire profile, proximity of road vulnerable users; or vehicle attributes.

10. The system of claim 1, wherein the machine learning component is configured to use reinforcement learning to generate the probabilistic-based assessment relating to operation of the vehicle.

11. A computer-implemented method comprising:
receiving by a system of a vehicle, vehicle environment data from a set of sensors along with current or historical weather data;
configuring by the system machine learning to train a model which that learns from vehicle environment, current or historical weather data, vehicle tire attributes, vehicle weight, vehicle speed, determined or inferred puddles and possibly other acquired data, and generates a probabilistic-based assessment relating to operation of the vehicle; and
generating by the system, based on the assessment provided by the trained model, a course of actions mitigating splashing of road users in proximity to the vehicle.

12. The method of claim 11, further executing by the system that is configurable to execute a method to utilize the trained model to apply the generated course of actions.

13. The method of claim 11, further comprising utilizing at least one of the set of sensors and the ML model to facilitate identifying water puddles and potholes on or adjacent to a road.

14. The method of claim 13, further comprising a set of sensors with at least one camera, and wherein the system is configured to identify an individual within proximity to the vehicle based on input from at least one camera.

15. The method of claim 14, further comprising notifying by the system, a driver of the vehicle of potential of splashing the individual.

16. The method of claim 11, further comprising utilizing, by the system, image processing and/or machine learning to identify the water puddles and then based on the current or historical weather data, the probability of a correctly identified water puddle is assessed.

17. The method of claim 11, further comprising by the system, utilization of information regarding current or historical weather conditions with a tire profile of the vehicle in connection to predict a splash by the vehicle.

18. The method of claim 11, further comprising storing by the system, locations of identified water puddles in a database for utilization by other vehicles.

19. The method of claim 11, further comprising estimating, by the system, risk or magnitude of splashing based on at least one of: distance to a puddle: puddle size and depth; vehicle speed; tire profile; proximity of road vulnerable users; or vehicle attributes.

20. The method of claim 11, further comprising utilizing, by the system, reinforcement learning to generate the probabilistic-based assessment relating to operation of the vehicle.
